(19) United States
(12) Patent Application Publication
(10) Pub. No.: US 2015/0323798 A1
(43) Pub. Date: Nov. 12, 2015

(54) SMART HELMET

(71) Applicants: Wei-Cheng Huang, Hsin-Chu (TW); Ming-Tsun Hung, Hsin-Chu (TW); Yi-Guo Tu, Hsin-Chu (TW)

(72) Inventors: Wei-Cheng Huang, Hsin-Chu (TW); Ming-Tsun Hung, Hsin-Chu (TW); Yi-Guo Tu, Hsin-Chu (TW)

(73) Assignee: CORETRONIC CORPORATION, Hsin-Chu (TW)

(21) Appl. No.: 14/609,439

(22) Filed: Jan. 30, 2015

(30) Foreign Application Priority Data
May 6, 2014 (TW) 103116073

(51) Int. Cl. G02B 27/01; H04H 40/27; G09G 5/10; H04H 20/57

(52) U.S. Cl. CPC G02B 27/0179; G02B 27/0176; G02B 27/0172; H04H 20/57; H04H 40/27; G09G 5/10; G09G 2360/144

(57) ABSTRACT

A smart helmet including a projection surface, a projection unit, a processing unit, and a first pivoting unit is provided. The projection unit projects an image light into the projection surface according to a projection data. The processing unit coupled to the projection unit, and provides the projection data to the projection unit. The first pivoting unit is adapted to adjust a projection angle of the projection unit projecting on the projection surface, and has three rotational degrees of freedom.

### CROSS-REFERENCE TO RELATED APPLICATION

This application claims the priority benefit of Taiwan application serial no. 103116073, filed on May 6, 2014. The entirety of the above-mentioned patent application is hereby incorporated by reference herein and made a part of this specification.

### BACKGROUND

1. Field of the Disclosure

The disclosure relates to a head mounted device, and more particularly, to a smart helmet.

2. Description of Related Art

In recent years, along with the great progress of display technology and related arts thereof, various wearable devices have been continuously developed, and a head mounted display (HMD) is one of them. In a conventional head mounted display, generally, the display may be fixedly disposed at a position where it keeps a predetermined distance with the human eyes, and there is no mounting adjusting mechanism. In addition, since the head shapes and positions of eyes of different users are different, the users may not achieve an optimum viewing quality when using the head mounted display.

The disclosures of U.S. Pat. No. 6,798,392, U.S. Pat. No. 8,001,623 and U.S. Patent Publication No. 20130305437 are related to head mounted displays.

The information disclosed in this description of related art is only for enhancement of understanding of the background of the described technology and therefore it may contain information that does not form the prior art that is already known to a person of ordinary skill in the art. Further, the information disclosed in the description of related art does not mean that one or more problems to be resolved by one or more embodiments of the invention was acknowledged by a person of ordinary skill in the art.

### SUMMARY OF THE DISCLOSURE

The disclosure provides a smart helmet adapted to match up with all the head shapes and positions of eyes of different users, such that the users achieve an optimum viewing quality when using the smart helmet.

Other objects and advantages of the disclosure can be further illustrated by the technical features broadly embodied and described as follows.

To achieve one, a part, or all of the objectives aforementioned or other objectives, one embodiment of the disclosure provides a smart helmet including a projection surface, a projection unit, a processing unit and a first pivoting unit. Herein the projection unit projects an image light beam onto the projection surface according to a projection data, the processing unit is coupled to the projection unit and provides the projection data to the projection unit. The first pivoting unit is adapted to adjust a projection angle of the projection unit projecting on the projection surface, wherein the first pivoting unit has three rotational degrees of freedom.

In an exemplary embodiment of the disclosure, the projection surface is a mask, and the image light beam forms a projection image on the mask.

In an exemplary embodiment of the disclosure, the smart helmet further includes a reflecting unit and a second pivoting unit. Herein the reflecting unit has a reflective mirror surface which serves as the projection surface, the second pivoting unit is pivoted between the projection unit and the reflecting unit, and is adapted to adjust a reflective angle of the reflecting unit reflecting the image light beam, so that the image light beam enters eyes of a viewer.

In an exemplary embodiment of the disclosure, the smart helmet further includes an audio receiving unit, an audio broadcasting unit and a wireless communication unit. The audio receiving unit is coupled to the processing unit and detects a sound for generating a received audio signal. The audio broadcasting unit is coupled to the processing unit. The wireless communication unit is coupled to the processing unit, controlled by the processing unit and transmits the received audio signal or receives an audio signal, wherein the processing unit controls the audio broadcasting unit to broadcast the audio signal according to the audio signal.

In an exemplary embodiment of the disclosure, the wireless controller communicates with the wireless communication unit and transmits a video-audio control signal to the processing unit via the wireless communication unit, so that the processing unit executes an operation corresponding to the audio control signal.

In an exemplary embodiment of the disclosure, the smart helmet further includes at least one camera unit coupled to the processing unit, wherein the processing unit controls the projection unit for projecting the image light beam according to an image captured by the at least one camera unit.

In an exemplary embodiment of the disclosure, the smart helmet further includes an optical sensing unit coupled to the processing unit and detects the light intensity of the environment, wherein the processing unit adjusts the light intensity of the image light beam according to a sensing result of the optical sensing unit.

In an exemplary embodiment of the disclosure, the smart helmet further includes an antenna coupled to the processing unit and receives a global positioning system (GPS) signal, wherein the processing unit controls the projection unit for projecting positioning information according to the GPS signal.

In an exemplary embodiment of the disclosure, the projection unit further includes an optical valve and a projection lens.

In an exemplary embodiment of the disclosure, the optical valve is a liquid crystal display (LCD) panel, a liquid crystal on silicon (LCOS) panel, or a digital micro-mirror device (DMD).

In light of the above, the first pivoting unit of the embodiment of the disclosure is provided with three rotational degrees of freedom, in order to adjust the projection angle of the projection unit projecting on the projection surface, and in order to match up with all the head shapes and positions of eyes of different users, such that the users achieve an optimum viewing quality when using the smart helmet.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a smart helmet according to one embodiment of the disclosure.

FIG. 2 is a schematic view illustrating a smart helmet according to one embodiment of the disclosure.

FIG. 3 is a schematic view illustrating a smart helmet according to another embodiment of the disclosure.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

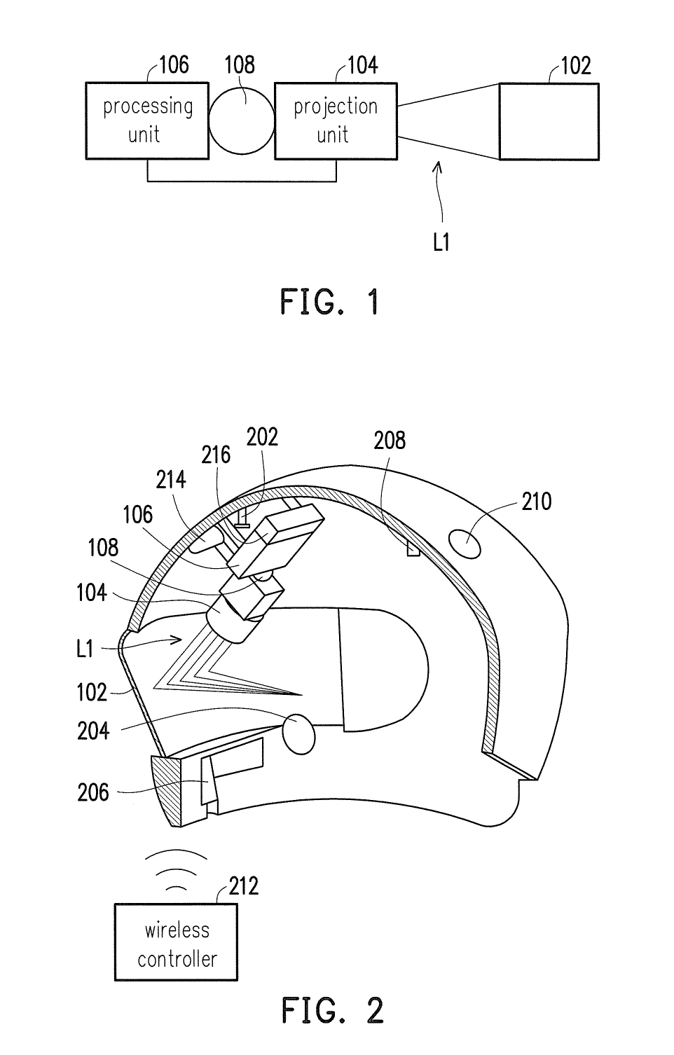

FIG. 1 is a block diagram illustrating a smart helmet according to one embodiment of the disclosure, referring to FIG. 1. The smart helmet includes a projection surface 102, a projection unit 104, a processing unit 106 and a first pivoting unit 108, wherein the projection unit 104 is coupled to the processing unit 106. The processing unit 106 provides a projection data to the projection unit 104, and the projection unit 104 projects an image light beam L1 onto the projection surface 102 according to the projection data. The first pivoting unit 108 is pivoted between the projection unit 104 and the processing unit 106. The first pivoting unit 108 may be a spherical pivot or a universal joint which has three rotational degrees of freedom, for example. By pivoting the first pivoting unit 108 between the projection unit 104 and the processing unit 106, the projection unit 104, taking the first pivoting unit 108 as a rotating center, may perform the adjustment of the projection angle of the projection unit 104, so that the projection unit 104 may perform projection with an optimum angle for the viewer, and so that different users may achieve the optimum viewing quality when wearing the smart helmet.

FIG. 2 is a schematic view illustrating a smart helmet according to one embodiment of the disclosure, referring to FIG. 2. In the embodiment, the projection surface 102 may be the mask of the helmet, and the image light beam L1 projected by the projection unit 104 may be projected onto the mask (the projection surface 102) to form the projection image for the users to watch. Herein the projection image may be navigation information or automobile dashboard information, for example. Through displaying the navigation information or the automobile dashboard information on the mask of the helmet, the users may not need to bow the head to watch the navigation information or the automobile dashboard information during driving, and driving safety of drivers may be improved. In addition, since the mask is already an existing component of a helmet, the users do not need extra cost for additional component.

Moreover, in addition to the projection surface 102, the projection unit 104, the processing unit 106 and the first pivoting unit 108, in the embodiment, the smart helmet further includes an optical sensing unit 202, an audio broadcasting unit 204, an audio receiving unit 206, an antenna 208, a camera unit 210, a camera unit 214, a wireless controller 212 and a wireless communication unit 216. Herein the optical sensing unit 202, the audio broadcasting unit 204, the audio receiving unit 206, the antenna 208, the camera unit 210, the camera unit 214 and the wireless communication unit 216 are coupled to the processing unit 106. For the sake of clearness, the coupling relationships therebetween are omitted in the drawing.

In light of the above, the optical sensing unit 202 may detects the light intensity of the external environment where the smart helmet is positioned, and the processing unit 106 may adjust the light intensity of the image light beam L1 according to the sensing result of the optical sensing unit 202, in order to prevent from the projection image being too bright or too dim, so that the users may clearly see the projection image under any environments of different light intensity, and the comfort ability and visibility of when the users watching the projection image may be enhanced. The audio broadcasting unit 204 may be an earphone or a speaker, the audio receiving unit 206 may be a microphone which is used for detecting a sound for generating a received audio signal. The wireless communication unit 216 may be a Bluetooth transmission module or a wireless fidelity (WiFi) transmission module which may perform wireless communication with a portable electronic device (e.g., a cell phone or a tablet computer). The processing unit 106 may transmit the received audio signal received from the audio receiving unit 206 to the portable electronic device through the wireless communication unit 216, and may also receive the audio signal transmitted from the portable electronic device through the wireless communication unit 216, and controls the audio broadcasting unit 204 to broadcast the sound according to the audio signal, for example. As such, through the wireless communication unit 216 and the portable electronic device performing the audio data transmission, the smart helmet may have hands-free call function. In some embodiments, the processing unit 106 may further transmit image information through the wireless communication unit 216, and has audio and video communication function.

In addition, the antenna 208 may receive a global positioning system (GPS) signal, so that the processing unit 106 may control the projection unit 104 for projecting positioning information according to the GPS signal and projecting the positioning information onto the mask. Furthermore, the camera unit 210 of the embodiment is the camera disposed behind the smart helmet, and the camera unit 214 is the camera disposed in front of the smart helmet. The camera units 210, 214 may respectively capture the front and rear of the road conditions during driving. The processing unit 106 may control the projection unit 104 to project the image light beam L1 according to the images captured by the camera units 210, 214. As such, the images captured by the camera units 210, 214 may serve as driving record (the driving record is stored in the storing device of the camera units 210, 214, for example), on the other hand information of the rear road condition may also be provided, so as to achieve the effect similar to the rear-view mirror, in order to increase the driving safety. It has to be noted that, in other embodiments, the quantity of the camera units is not limited thereto, and the users may increase or reduce the quantity of the camera units according to actual condition. In addition, the wireless controller 212 may communicate with the wireless communication unit 216, and transmits a video-audio control signal to the processing unit 106 via the wireless communication unit 216, so that the processing unit 106 executes an operation corresponding to the video-audio control signal, for example, adjusting the volume of the audio broadcasting unit 204, adjusting the brightness of the projection image, and so on. In some embodiments, the wireless controller 212 may be actualized by a smart phone or a tablet computer, for example, and the wireless controller 212 may be fixed to the handle, the dashboard of motorcycle or user's hand, e.g., a smart watch, for facilitating the user to operate remote control.

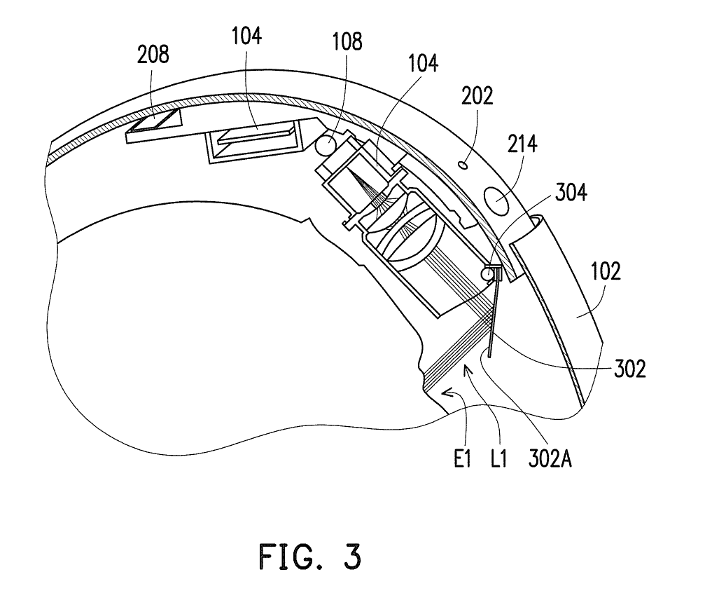

FIG. 3 is a schematic view illustrating a smart helmet according to another embodiment of the disclosure, referring to FIG. 3. In the embodiment, compared to the embodiment of FIG. 2, the smart helmet further includes a reflecting unit 302 and a second pivoting unit 304. The reflecting unit 302 has a reflective mirror surface 302A which serves as the projection surface, and the second pivoting unit 304 is pivoted between the projection unit 104 and the reflecting unit 302. Similarly, the second pivoting unit 304 may be a spherical pivot or a universal joint which has three rotational degrees of freedom. Through pivoting the second pivoting unit 304 between the projection unit 104 and the reflecting unit 302, the reflective angle of the reflecting unit 302 which reflects the image light beam L1 may be adjusted, so that the image light beam L1 enters eyes E1 of a viewer. It should be noted that the reflecting unit 302 may rotate by taking the second pivoting unit 304 as a rotating center, and is retrieved beyond the view vision of the viewer when the projection unit 104 does not perform projection, so as to prevent from blocking the view vision of the user. Or, when the user wants to project the image light beam L1 onto the mask, the reflecting unit 302 may be removed to be away from the projecting path of the image light beam L1, so that the image light beam L1 may be displayed on the mask as the projection image.

In light of the foregoing, the first pivoting unit of the embodiment of the disclosure is provided with three rotational degrees of freedom, in order to adjust the projection angle of the projection unit projecting on the projection surface, and in order to match up with all the head shapes and positions of eyes of different users, such that the users achieve an optimum viewing quality when using the smart helmet. In some embodiments, the second pivoting unit may also be pivoted between the projection unit and the reflecting unit, and by adjusting the reflective angle of the reflecting unit reflecting the image light beam, the image light beam enters eyes of a viewer, so as to ensure that the user achieves the optimum viewing quality. In addition, the optical sensing unit, the audio broadcasting unit, the audio receiving unit, the antenna, the camera units, the wireless controller and the wireless communication unit may also be additionally disposed on the smart helmet, for further improving the functions of the smart helmet.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

Moreover, these claims may refer to use “first,” “second,” etc. following with noun or element. Such terms should be understood as a nomenclature and should not be construed as giving the limitation on the number of the elements modified by such nomenclature unless specific number has been given.

What is claimed is:

1. A smart helmet, comprising:
a projection surface;
a projection unit, projecting an image light beam onto the projection surface according to a projection data;
a processing unit, coupled to the projection unit and providing the projection data to the projection unit; and
a first pivoting unit, adapted to adjust a projection angle of the projection unit projecting onto the projection surface, wherein the first pivoting unit has three rotational degrees of freedom.

2. The smart helmet as claimed in claim 1, wherein the projection surface is a mask, and the image light beam forms a projection image on the mask.

3. The smart helmet as claimed in claim 1, further comprising:
a reflecting unit, having a reflective mirror surface which serves as the projection surface; and
a second pivoting unit, pivoted between the projection unit and the reflecting unit, adapted to adjust a reflective angle of the reflecting unit reflecting the image light beam, so that the image light beam enters eyes of a viewer.

4. The smart helmet as claimed in claim 1, further comprising:
an audio receiving unit, coupled to the processing unit and detecting a sound for generating a received audio signal;
an audio broadcasting unit, coupled to the processing unit; and
a wireless communication unit, coupled to the processing unit, controlled by the processing unit and transmitting the received audio signal or receiving an audio signal, wherein the processing unit controls the audio broadcasting unit to broadcast according to the audio signal.

5. The smart helmet as claimed in claim 4, further comprising:
a wireless controller, communicating with the wireless communication unit, transmitting a video-audio control signal to the processing unit via the wireless communication unit, so that the processing unit executes an operation corresponding to the video-audio control signal.

6. The smart helmet as claimed in claim 1, further comprising:
at least one camera unit, coupled to the processing unit, wherein the processing unit controls the projection unit for projecting the image light beam according to an image captured by the at least one camera unit.

7. The smart helmet as claimed in claim 1, further comprising:
an optical sensing unit, coupled to the processing unit, wherein the processing unit adjusts a light intensity of the image light beam according to a sensing result of the optical sensing unit.

8. The smart helmet as claimed in claim 1, further comprising:
an antenna, coupled to the processing unit, receiving a global positioning system signal, wherein the processing unit controls the projection unit for projecting positioning information according to the global positioning system signal.

9. The smart helmet as claimed in claim 1, wherein the projection unit comprises an optical valve and a projection lens.

10. The smart helmet as claimed in claim 9, wherein the optical valve is a liquid crystal display (LCD) panel, a liquid crystal on silicon (LCOS) panel, or a digital micro-mirror device (DMD).
